(19) United States
(12) Patent Application Publication
(10) Pub. No.: US 2018/0279087 A1
(43) Pub. Date: Sep. 27, 2018

(54) LOCATION TRACKING SYSTEM AND TRACKING DEVICE

(71) Applicant: FocusOn Technologies Co., Limited, SHANGHAI (CN)

(72) Inventors: SHAO-CHUN CHEN, HUALIEN COUNTY (TW); LI-MING HUANG, CHIAYI COUNTY (TW)

(21) Appl. No.: 15/902,749

(22) Filed: Feb. 22, 2018

Related U.S. Application Data
(60) Provisional application No. 62/474,166, filed on Mar. 21, 2017.

(51) Int. Cl. H04W 4/029; H04W 4/02; H04W 4/80

(52) U.S. Cl. CPC H04W 4/029; H04W 88/02; H04W 4/80; H04W 4/023

(57) ABSTRACT

A tracking device is provided in the present disclosure for communicating with an electronic device. The tracking device includes a processing module; and a communication electrically connected to the processing module. The tracking device communicates with the electronic device through the communication module. The processing module of the tracking device listens to a second detecting signal of another tracking device for detecting the another tracking device through the communication module. The second detecting signal is a broadcast signal.

### BACKGROUND OF THE INVENTION

### 1. Field of the Invention

The present disclosure relates to a location tracking system and a tracking device; in particular, to a location tracking system and a tracking device that are cost-effective and with low power consumption.

### 2. Description of Related Art

A mesh network is a kind of communication system including a number of nodes and a lot of data and control intrusions are transmitted through the dynamic routing thereof. When a mesh network is used in a location tracking system, the cost and the power consumption cannot be reduced.

Therefore, it is necessary to provide a location tracking system that is cost-effective and with low power consumption.

### SUMMARY OF THE INVENTION

A tracking device is provided in the present disclosure for communicating with an electronic device based on a Bluetooth standard. The tracking device includes a processing module; and a communication electrically connected to the processing module. The tracking device communicates with the electronic device through the communication module. The processing module of the tracking device listens to a second detecting signal of another tracking device for detecting the another tracking device through the communication module. The second detecting signal is a broadcast signal. When the tracking device listens to the second detecting signal of another tracking device, the electronic device provides a location signal to a server.

A location tracking system includes a plurality of fixed station, respectively located in a predetermined area; and a first tracking device communicated with an electronic device; wherein at least one of the fixed station communicates with a communication device, when the first tracking device enters the predetermined area, an event signal that the first tracking device enters the predetermined area is transmitted by at least one of the fixed station to a server through the communication device; wherein the event signal includes a location information of the electronic device and a device code of the first tracking device.

A location tracking system includes a first tracking device, transmitting and listening based on a reference clock signal; and a second tracking device, transmitting and listening based on a reference clock signal; a second tracking device, transmitting and listen based on the reference clock signal; wherein the reference clock signal includes a plurality of first time intervals, each first time interval includes one second time interval, wherein the first tracking device and the second tracking device transmit and listen to broadcast signals in the second time intervals of each first time interval. A location tracking system includes a tracking device; a first communication device; a second communication device; and five fixed stations located in a predetermined area, each of the five fixed stations transmitting event signals to a server through the first communication device or the second communication device when an event is triggered, the each fixed station having a fixed station code. The first communication device transmits a first ping request to the five fixed stations and records a first ping request time, each of the five fixed stations transmits a first response signal to the first communication device according to the first ping request corresponding to the first ping request, the second communication device transmits a second ping request to the five fixed stations and records a second ping request time corresponding to the second ping request. Each of the five fixed stations transmits a second response signal to the second communication device according to the second ping request. When the first communication device or second communication device receives the response signals of the fixed stations, the first communication device or the second communication device records each receiving time of the response signals of the fixed stations transmitted by the fixed stations to the first communication device or the second communication device. The first communication device determines first elapsed times of the fixed stations based on the response times of the fixed stations and the first ping request time, the second communication device determines second elapsed times of the fixed stations based on the response times of the fixed stations and the second ping request time. The first communication device and the second communication device transmit the first elapsed times of the fixed stations, the second elapsed times of the fixed stations to the server, the server generates a maximum delivery time interval based on the first elapsed times of the fixed stations and the second elapsed times. When the tracking device enters the predetermined area, at least one of the fixed stations detects the tracking device and transmits the event signal that the tracking device enters the predetermined area to the server through the first communication device or the second communication device. the first communication device and the second communication device transmit the event signal and detecting time of the event signal that is detected by the one of the fixed stations to the server, the detecting time of the event signal are determined by the first communication device or the second communication device based on receiving times of the event signal received by the first communication device or the second communication device and the elapsed times of the one of the fixed stations recorded in the first communication device or the second communication device. The event signal includes the fixed station code of the at least one of the fixed stations that detects the tracking device, the event signal includes the fixed station code of the at least one of the fixed stations that detects the tracking device, when the server determines the maximum delivery time interval, the server transmits the maximum delivery time interval to the first communication device and the second communication device to notice all the fixed stations for transmitting the event signals in the maximum delivery time interval, the event signal detected by one fixed station is transmitted to the server only one time in one maximum delivery time interval.

According to the above, the tracking system in the present disclosure uses the tracking devices that synchronize with a reference clock signal of the sever, and the tracking devices transmit and listen to the detecting signals as the nodes of the mesh network in the same time interval for transmitting the events or the status of the tracking devices of the mesh networks to a remote server. The location of the tracking device can be determined, accordingly. The tracking device in the present disclosure includes a Bluetooth communication module or a Bluetooth low energy communication module, which the power consumption of those is lower.

For further understanding of the present disclosure, reference is made to the following detailed description illustrating the embodiments of the present disclosure. The description is only for illustrating the present disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 is a schematic diagram of a location tracking system according to an embodiment of the present disclosure.

FIG. 2 is a schematic diagram of a tracking device according to an embodiment of the present disclosure.

FIG. 3 is a schematic diagram of a fixed station according to an embodiment of the present disclosure.

FIG. 4 is another schematic diagram of a location tracking system according to an embodiment of the present disclosure.

FIG. 5 is a schematic diagram of a reference clock signal of a server according to the embodiment of the present disclosure.

### DETAILED DESCRIPTION OF EXEMPLARY EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

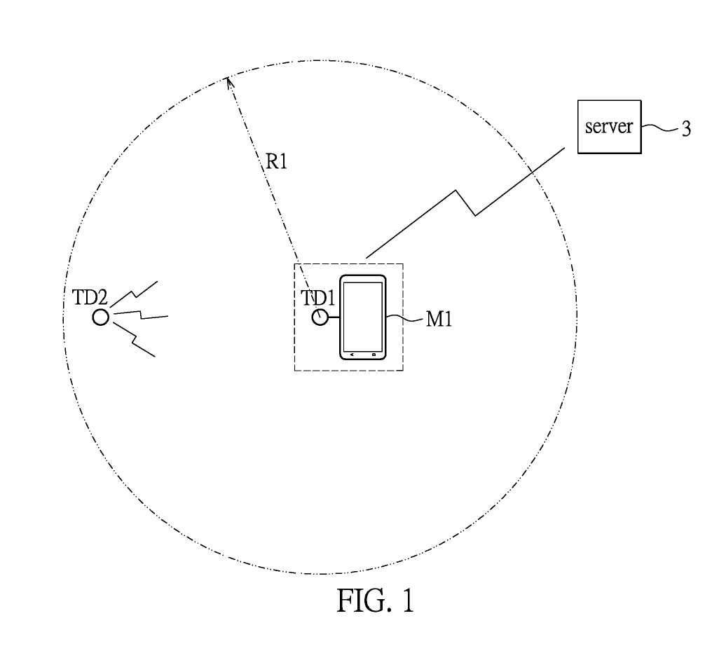

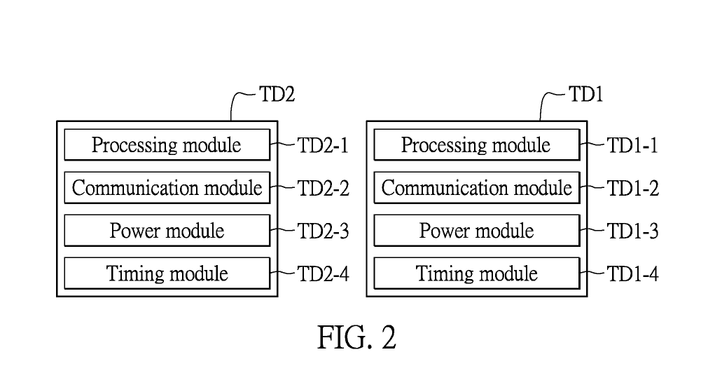

Referring to FIG. 1 and FIG. 2, FIG. 1 is a schematic diagram of a tracking system according to an embodiment of the present disclosure. FIG. 2 is a schematic diagram of a tracking device according to an embodiment of the present disclosure.

In the embodiment, a location tracking system includes a first tracking device TD1 and a second tracking device TD2. The first tracking device TD1 communicates to a first electronic device M1. In the embodiment, the first tracking device TD1 communicates with the first electronic device M1 based on the Bluetooth standard.

Referring to FIG. 2, the first tracking device TD1 includes a processing module TD1-1, a communication module TD1-2, a powering module TD1-3, and a timing module TD1-4. The structure and function of the second tracking device TD2 are similar to those of the first tracking device TD1. The second tracking device TD2 includes a processing module TD2-1, a communication module TD2-2, a powering module TD2-3, and a timing module TD2-4.

In the embodiment, the processing module TD1-1 of the first tracking device TD1 is electrically connected to the communication module TD1-2, the powering module TD1-3, and the timing module TD1-4. The processing module TD2-1 of the second tracking device TD2 is electrically connected to the communication module TD2-2, the powering module TD2-3, and the timing module TD2-4.

The powering module TD1-3 of the first tracking device TD1 or the powering module TD2-3 of the second tracking module TD2 includes a battery, an AC to DC voltage converter, or a DC to DC voltage converter. In the embodiment, the powering module TD1-3 of the first tracking device is a portable battery, such as a button battery.

In the embodiment, the first tracking device TD1 and the second tracking device TD2 can further include motion sensors (not shown). When the motion sensor (not shown) of the first tracking device TD1 detects the first tracking device TD1 that stays in the same area, the first tracking device TD1 reduce a frequency of transmitting the first detecting signal for power saving. In other words, when the first tracking device TD1 moves across a long distance in a short time, the frequency of transmitting the detecting signal is increased.

In the embodiment, the first tracking device TD1 and the second tracking device TD2 have a predetermined detecting distance R1. The predetermined detecting distance R1 is determined based on the power of the detecting signal.

In the embodiment, the first tracking device TD1 periodically transmits a first detecting signal, and the second tracking device TD2 also periodically transmits a second detecting signal, i.e., the processing module TD1-1 of the first tracking device TD1 periodically transmits a first detecting signal through the communication module TD1-2, and the processing module TD2-1 of the second tracking device TD2 periodically transmits a second detecting signal through the communication module TD2-2. In the embodiment, the first detecting signal and the second detecting signal are broadcast signals.

Referring to FIG. 1, the first tracking device TD1 in FIG. 1 communicates with first electronic device M1. The first tracking device TD1 is registered in a server 3 to be enabled through at least one registering device, i.e., a registered tracking device of the server 3 should be enabled through one registering device. In the embodiment, the first tracking device TD1 can be registered through the first electronic device M1. In the embodiment, the first electronic device M1 is a mobile device. In the other embodiment, the first tracking device TD1 can be registered in the server 3 through the other registering device, includes a tablet, a personal computer, a mobile device, a router, a gateway or a wearable electronic device, but not limited in the present disclosure. For power saving, the first tracking device TD1 can be set for just listening to the detecting signals of other tracking device when the first tracking device TD1 communicates with the first electronic device M1. In other embodiment, the first tracking device TD1 can be set for listening and transmitting the detecting signals when the first tracking device TD1 communicates with the first electronic device M1, which is not limited in the present disclosure. In addition, the first tracking device TD1 and the second tracking device TD2 do not transmit and listen to the detecting signals when the first tracking device TD1 and the second tracking device TD2 are not enabled or registered in the server 3.

In the embodiment, timing module TD1-4 of the first tracking device TD1 and the timing module TD2-4 of the second tracking device TD2 synchronize with a reference clock signal of a server 3 when the first tracking device TD1 and the second tracking device TD2 are registered in the server 3. Therefore, the timing module TD1-4 of the first tracking device TD1 and the timing module TD2-4 of the second tracking device TD2 will counts according to the reference clock signal, i.e., the actions of transmitting and receiving signal of the first tracking device TD1 and the second tracking device TD2 are based on the same reference clock signal. In addition, the first tracking device TD1 and the second tracking device TD2 periodically transmit and listen to signals in the same time interval. Therefore, the first tracking device TD1 and the second tracking device TD2 synchronously transmit and listen to the detecting signals in the same time interval of the reference clock signal.

In the embodiment, the time sequences of transmitting signal and receiving signal of the first tracking device TD1 and the second tracking device TD2 can be variable based on the practical requirement, which is not limited in the present.

In the embodiment, the first tracking device TD1 and the second tracking device TD2 have predetermined detecting distances R1. When the second tracking device TD2 is detected in the predetermined detecting distance R1, the processing module TD1-1 of the first tracking device TD1 transmits a notice signal to the electronic device M1 through the communication module. The electronic device M1 transmits a location signal to the server 3, i.e., when the user takes the electronic device M1 and the first tracking device TD1 to be nearby the second tracking device TD2, the first tracking device TD1 can listen to the second detecting signal of the second tracking device TD2. The first tracking device TD1 transmits a notice signal to the electronic device M1 based on the second detecting signal of the second tracking device TD2. In the embodiment, the electronic device M1 transmits a location signal to the server 3. The location signal includes at least a first device code of the first tracking device TD1, a second device code of the second tracking device TD2, and the location information of the electronic device. When the sever 3 receives the location signal transmitted from the first electronic device M1, the server can determine the locations of the second tracking device TD2. In addition, the location signal can further include a received signal strength value (Received Signal Strength Indicator) that the first tracking device TD1 detects the second tracking device TD2. Therefore, in the embodiment, the location information of the electronic device includes latitude and longitude of the electronic device, accuracy, address on the map and the received signal strength value. Accordingly, the server 3 can precisely determines the location of the second tracking device TD2 according to the location signal of the first electronic device M1.

The notice signal includes a first device code of the first tracking device TD1, a detecting time detecting the second tracking device TD2, a reason of the notice signal, and a content of the reason. The reason of the notice signal can be categorized according to the connection type of the tracking device into: 1) actions of a tracking device that is not connected to an electronic device, 2) actions of a tracking device connected to an electronic device, 3) actions of a tracking device detected by another tracking device; 4) actions of a tracking device detected by a mesh network. Furthermore, the actions of the tracking device can be includes more categories according to different situations. The content of the reason includes a second device code of the second tracking device TD2, the information of the electronic device M1 or other information of the second tracking device TD2, such as power status, network status, but being not limited in the present disclosure.

In the embodiment, the second tracking device TD2 is a lost tracking device, i.e., the second tracking device TD2 does not communicate to other electronic device. Therefore, the second tracking device TD2 continuously and periodically transmits a second detecting signal (broadcast signal) for being tracked by other tracking device.

In the embodiment, the communication module TD1-2 of the first tracking device TD1 or the communication module TD2-2 of the second tracking device TD2 is a Bluetooth communication module. In the embodiment, the communication module TD1-2 of the first tracking device TD1 includes Bluetooth 4.0, Bluetooth 4.1, Bluetooth 4.2, Bluetooth 5, or other Bluetooth standard, but being not limited in the present disclosure. In the embodiment, the communication module TD1-2 of the first tracking device TD1 or the communication module TD2-2 of the second tracking device TD2 includes a Bluetooth communication module or a Bluetooth Low Energy Communication module. In other words, the first tracking device TD1 communicates with first electronic device M1 based on the Bluetooth standard.

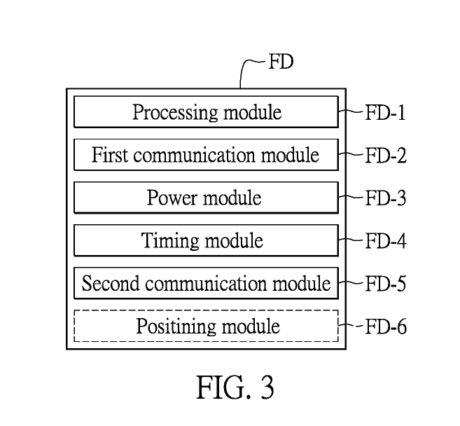

Referring to FIG. 3, FIG. 3 is a schematic diagram of a fixed station according to an embodiment of the present disclosure.

In the embodiment, the fixed station FD is designed for located in a fixed location. The fixed station FD includes a processing module FD-1, a first communication module FD-2, a power module FD-3, a timing module FD-4, and a second communication module FD-5. In the embodiment, the processing module FD-1, the first communication module FD-2, and the timing module FD-4 of the processing module TD1-1, the communication module TD1-2 and the timing module TD1-4 of the first tracking device TD1, which the description of those are omitted in the embodiment. In the embodiment, the power module FD-3 of the fixed station FD includes a long lifetime battery, a DC-DC converter, and an AC-DC converter, but being not limited in the present disclosure. The second communication module FD-5 of the fixed station FD includes a wireless communication module and a wired communication module. In the embodiment, the fixed station FD communicates with a communication device through the second communication module FD-5. The communication device includes a router, a gateway device or a mobile device, but being not limited in the present disclosure. In the embodiment, the second communication module FD-5 is a Bluetooth communication module, when the second communication module FD-5 is a wireless communication module. In the embodiment, the fixed station can further include a positioning module FD-6 for detecting the location information of the fixed station FD. In the embodiment, the second communication module FD-5 and the positioning module FD-6 are just optional modules.

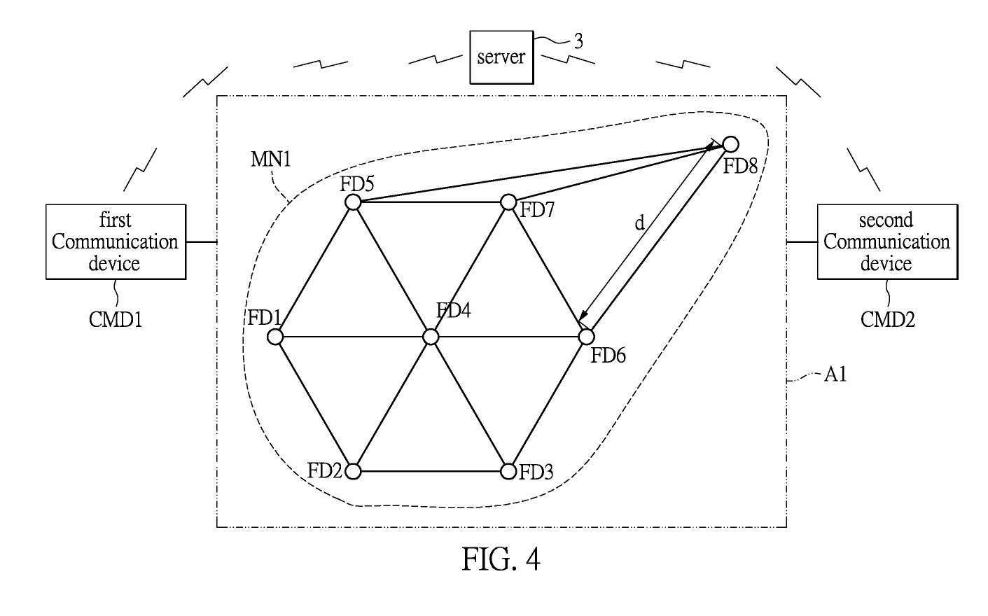

Referring to FIG. 4, in the embodiment, the location tracking system 1 includes a mesh network MN1, a first communication device CMD1, a second communication device CMD2. In the embodiment, the mesh network MN1 includes a first fixed station FD1, a second fixed station FD2, a third fixed station FD3, a fourth fixed station FD4, a fifth fixed station FD5, a sixth fixed station FD6, a seventh fixed station FD7, and an eighth fixed station FD8. The fixed stations of the mesh network MN1 are located in a predetermined area A1. In the embodiment, the first fixed station FD1, the second fixed station FD2, the third fixed station FD3, the fourth fixed station FD4, the fifth fixed station FD5, the sixth fixed station FD6, the seventh fixed station FD7, and the eighth fixed station FD8 are located at different fixed positions of the predetermined area A1. One of the fixed stations of the mesh networks MN1 communicates with at least one of the other fixed stations thereof. In the embodiment, the total coverage of the mesh network MN1 includes a first fixed station FD1, a second fixed station FD2, a third fixed station FD3, a fourth fixed station FD4, a fifth fixed station FD5, a sixth fixed station FD6, a seventh fixed station FD7, and an eighth fixed station FD8 can cover the predetermined area A1. In other embodiment, the range of the predetermined area Al is determined by the first fixed station FD1, the second fixed station FD2, the third fixed station FD3, the fourth fixed station FD4, the fifth fixed station FD5, the sixth fixed station FD6, the seventh fixed station FD7, and the eighth fixed station FD8. In the embodiment, a number of the fixed stations is variable and designed based on the practical request. In some embodiment, the number of the fixed stations can be larger than 30000.

In the embodiment, the first communication device CMD1 and the second communication device CMD2 ping each of the fixed stations of the mesh network MN1, i.e., the first communication device CMD1 and the second communication device CMD2 transmit the ping requests to all of the fixed stations of the networks MN1. Each fixed station of the mesh network MN1 transmits a response signal to the first communication device CMD1 or the second communication device CMD2 when the each fixed station of the mesh network MN1 listens to the ping requests of the first communication device CMD1 and the second communication device CMD2. In the embodiment, when the first communication device CMD1 transmits first ping requests to the fixed stations of the mesh network MN1, the first communication device CMD1 records a first ping request time corresponding to the first ping request. Similarly, when the second communication device CMD2 transmits second ping requests to the fixed stations of the mesh network MN1, the second communication device CMD1 records a second ping request time corresponding to the first ping request.

When the first communication device CMD1 or the second communication device CMD2 receives the response signals of the fixed stations of the mesh networks, the first communication device CMD1 or the second communication device CMD2 also record the receiving times of the response signals of the fixed stations. In addition, the first communication device CMD1 calculates a first elapsed time of each fixed station that is between the response time of each fixed station and the first ping request time. The second communication device CMD2 calculates a second elapsed time of each fixed station that is between the response time recorded by the second communication device CMD2 of each fixed station and the second ping request time. In addition, each of the fixed stations of the mesh network MN1 has an unique fixed station code. In the embodiment, the first communication device CMD1 and the second communication CMD2 respectively transmits the first elapsed times of the fixed stations and the second elapsed times of the fixed stations to the server 3. The server 3 sorts the first elapsed times and the second elapsed times of the fixed stations. When the sever 3 receives all of the first elapsed times and the second elapsed times of the fixed stations, i.e., each fixed station has at least one elapsed time in the server 3, the server 3 stops to receive the data transmitted from the first communication device CMD1 or the second communication device CMD2.

In the embodiment, the first fixed station FD1, the second fixed station FD2, the third fixed station FD3, the fourth fixed station FD4, the fifth fixed station FD5, the sixth fixed station FD6, the seventh fixed station FD7, and the eighth fixed station FD8 can transmit the response signals corresponding to the first ping request and the second ping request, i.e., the first fixed station FD1, the second fixed station FD2, the third fixed station FD3, the fourth fixed station FD4, the fifth fixed station FD5, the sixth fixed station FD6, the seventh fixed station FD7, and the eighth fixed station FD8 transmit first response signals corresponding to the first ping request to the first communication device CMD1, and second response signals corresponding to the second ping request to the second communication device CMD2.

Referring to FIG. 4, the response signals transmitted to the first communication device CMD1 of the first fixed station FD1, the second fixed station FD2, the third fixed station FD3, the fourth fixed station FD4 and the fifth fixed station FD5 are earlier than those of the sixth fixed station FD6, the seventh fixed station FD7, and the eighth fixed station FD8. Similarly, the response signals transmitted to the second communication device CMD2 of the first fixed station FD1, the second fixed station FD2, the third fixed station FD3, the fourth fixed station FD4 and the fifth fixed station FD5 are later than those of the sixth fixed station FD6, the seventh fixed station FD7, and the eighth fixed station FD8.

In the embodiment, the first communication device CMD1 records the response times corresponding to the response signals according to the receiving time that the first communication device CMD1 receives the response signal of the fixed station, and calculates the first elapsed times of the fixed stations. Therefore, the first elapsed times of the first fixed station FD1, the second fixed station FD2, the third fixed station FD3, the fourth fixed station FD4 and the fifth fixed station FD5 are less than the second elapsed times of the first fixed station FD1, the second fixed station FD2, the third fixed station FD3, the fourth fixed station FD4 and the fifth fixed station FD5. Similarly, the first elapsed times of the sixth fixed station FD6, the seventh fixed station FD7, the eighth fixed station FD8 are greater than the second elapsed times of the sixth fixed station FD6, the seventh fixed station FD7, the eighth fixed station FD8. In the embodiment, the first elapsed times are stored in the first communication device CMD1, and the second elapsed times are stored in the second communication device CMD2.

When the first communication device CMD1 and the second communication device CMD2 transmit the first elapsed times and the second elapsed times of the fixed stations to the server 3, the server 3 can sort the elapsed times transmitted from the first communication device CMD1 and the second communication device CMD2. In the embodiment, the maximum elapsed time of the fixed station transmitted from the first communication device CMD1 and the second communication device CMD2 is the first elapsed time or the second elapsed time of the third fixed station FD3. The sever 3 can use the first elapsed time or the second elapsed time of the third fixed station FD3 to determine a maximum delivery time interval of the mesh network MN1. In the embodiment, the maximum delivery time interval of the mesh network MN1 is the maximum delivery time interval to collect all the event signals of the fixed stations of the mesh network MN1. In other words, the server 3 can put the first elapsed times and the second elapsed times of the fixed stations in sequence from the minimum value to the maximum value, and the server 3 can find one specific elapsed time that all of the fixed stations can transmit the response signals to the first communication device CMD1 or the second communication device CMD2 in the specific elapsed time.

In the embodiment, the maximum delivery time interval of the mesh network MN1 is larger than or equal to the maximum elapsed time of the fixed station divided by an adjusting parameter. The adjusting parameter can be adjustable by the situation of the mesh network MN1. In general, the adjusting parameter is “2” that the response time is two times of the transmitting time from the fixed station to the first communication device CMD1 or the second communication device CMD2.

In the embodiment, each of the fixed stations can transmit the event signals of the tracking device to the server 3 in one maximum delivery time interval, i.e., the event detected by one fixed station can be transmitted to the server 3 only one time in one maximum delivery time interval, which the event signal detected by one fixed station in the maximum delivery time interval cannot be transmitted two times to the server 3. When the server 3 determines the maximum delivery time interval of the mesh network MN1, the server 3 transmits the maximum delivery time interval to the first communication device CMD1 and the second communication device CMD2 to notice all the fixed stations for transmitting the event signals in the maximum delivery time interval. If a third communication device CMD3 (not shown) is added in the mesh network MN1, the new communication device can transmit the ping requests to the fixed stations once again, and the sever 3 can also calculate a new maximum delivery time based on the elapsed times of the fixed stations transmitted by the first communication device CMD1, the second communication device CMD2, and the third communication device CMD3 (not shown). In other embodiment, the first communication device CMD1 and the second communication device CMD2 can periodically transmit the ping request to the fixed stations to calculate the maximum delivery time interval, i.e., one day or one week. In other words, the maximum delivery time interval can be updated by the server 3 according to the practical request, which is not limited in the present disclosure.

In the embodiment, the first tracking device TD1 that does not communicate with an electronic device (not shown). When the first tracking device TD1 enters the predetermined area A1, i.e., when the first tracking device TD1 electronic device enters the predetermined detecting distance R1 of one fixed station of the mesh network MN1, an event that the first tracking device TD1 is detected by at least one of the fixed stations. The event is transformed into a notice signal to notice the other fixed stations. Therefore, the first fixed station FD1, the second fixed station FD2, the third fixed station FD3, the fourth fixed station FD4, the fifth fixed station FD5, the sixth fixed station FD6, the seventh fixed station FD7 and the eighth fixed station FD8 will have all the triggered events in the mesh network MN1. In the embodiment, the fixed stations are enabled through a registering device and registered in the server 3. In addition, the all location information of the first fixed station FD1, the second fixed station FD2, the third fixed station FD3, the fourth fixed station FD4, the fifth fixed station FD5, the sixth fixed station FD6, the seventh fixed station FD7, and the eighth fixed station FD8 are predetermined in the server 3. In the embodiment, the location information of the fixed stations is the geographical information or the user-defined location information, but being not limited in the present disclosure. The geographical information includes a global position system (GPS) information or the address, but being not limited in the present disclosure. In the embodiment, each fixed station of the mesh network MN1 can transmit event signals to the server 3 through the first communication device CMD1 or the second communication device CMD2. In the embodiment, the elapsed times of the fixed stations for transmitting the event signals are also recorded by the server 3. In the embodiment, when the first tracking device TD1 moves in the predetermined area A1 and being detected by different fixed stations of the mesh network MN1, the different fixed stations transmit different event signals that respectively include the fixed station codes.

In the embodiment, according to power modules of the first fixed station FD1, the second fixed station FD2, the third fixed station FD3, the fourth fixed station FD4, the fifth fixed station FD5, the sixth fixed station FD6, the seventh fixed station FD7, and the eighth fixed station FD8 include at least a long lifetime battery or being connected an AC source or a DC source, the fixed stations can continuously listen to the detecting signals (broadcast signals) of other tracking device or the fixed stations. In the embodiment, the event content includes the location information of the electronic device (not shown), and a device code of the first tracking device TD1.

In the embodiment, the event further includes a tracking device joining the mesh network, a tracking device quitting the mesh work, or a low power notice of a tracking device, but not being limited in the present disclosure.

In the embodiment, the first fixed station FD1 and the fifth fixed station FD5 communicate with the first communication device CMD1 through the second communication modules thereof. However, the second communication modules of the second fixed station FD2 and the third fixed station FD3 can be different or the same with each other, which is not limited in the present disclosure. In the embodiment, when the first tracking device TD1 joins the mesh network MN1, the fixed stations transmit the event signal of the first tracking device TD1 to each other. The event signal at least includes the device code of the first tracking device TD1. The event signal can further include the received signal strength value of each fixed station of the mesh network MN1. When the event signals of the fixed stations transmitted to the server 3 through the first communication device CMD1 and the second communication device CMD2, the location of the first tracking device TD1 can be detected based on the elapsed times of the fixed stations, the receiving time of the event signal that is received by the first communication device or the second communication device, and the received signal strength values of the fixed stations. In other words, the location of the first tracking device TD1 can be detected based on the detecting time detected by one of the fixed stations, and the received signal strength values of the fixed stations. The detecting time detected by one of the fixed stations can be calculated by using receiving times of the first communication device CMD1 or the second communication device CMD2 minus the elapsed time of the one of the fixed stations. The first communication device CMD1 and the second communication device CMD2 transmit the detecting time detected by one of the fixed stations to the server 3 for determining the location of the first tracking device TD1.

In the embodiment, the location of the first tracking device TD1 can be detected by the maximum received signal strength value or a triangle positioning method, which is not limited in the present disclosure. In the embodiment, the event signal at least includes a device code of that detects the first tracking device TD1.

In the embodiment, the first communication device CMD1 and the second communication device CMD2 include a fixed communication device and a mobile communication device, but being not limited in the present disclosure, i.e., when the communication device CMD1 is a mobile communication device, the fixed station connected to the communication device CMD1 can be considered as a transmitting node for transmitting signals. In addition, a number of the communication devices is “two” in the embodiment, and the number of the communication device can be variable according to the practical requirement in other embodiment. When the server 3 receives the signals transmitted by the mesh network MN1, the server 3 can determine the location of the first tracking device TD1 in the mesh network MN1 according to the predetermined locations of the fixed stations and the location signal of the first tracking device TD1. Moreover, the server 3 can precisely determine the location of the first tracking device TD1 in the minimum delivery time interval according to the predetermined locations of the fixed stations, the location signal of the first tracking device TD1 and the received signal strength values of the fixed stations of the mesh network MN1.

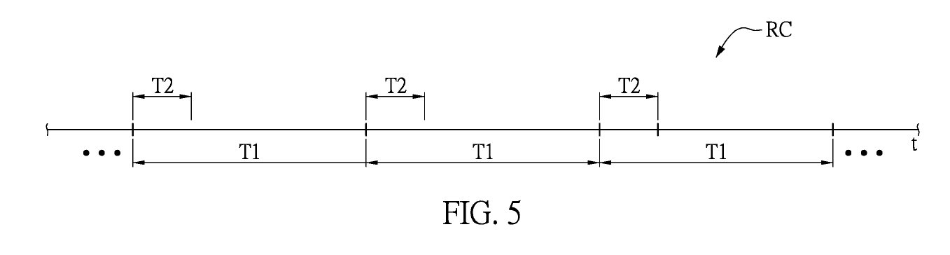

Referring to FIG. 1 and FIG. 5, FIG. 5 is a schematic diagram of a reference clock signal of a server according to the embodiment of the present disclosure.

In the embodiment, the location tracking system 1 includes a first tracking device TD1 and a second tracking device TD2. The first tracking device TD1 and the second tracking device TD2 are enabled through at least one registering device and registered in the server 3.

In the embodiment, the first tracking device TD1 transmits a first detecting signal and listens to the detecting signals of the other tracking device based on a reference clock signal RC of the server 3. Similarly, the second tracking device TD2 transmits a second detecting signal and listens to the detecting signals of the other tracking device based on the reference clock signal RC of the server 3. In other words, the first tracking device TD1 and the second tracking device TD2 of the location tracking system 1 transmit and listen to the detecting signals based on the same reference clock signal.

In the embodiment, the reference clock signal RC of the server 3 includes a plurality of first time intervals T1. Each first time interval T1 includes a second time interval T2. In the embodiment, the second time interval T2 is less than the first time interval T1. In addition, the arrangements of the second time interval T2 in each first time interval T1 are the same. In other words, the first tracking device TD1 and the second tracking device TD2 can transmit and listen to the detecting signals in the same time interval of each first time interval.

In other embodiment, the first time interval T1 and the second time interval T2 are variable and programmable, which can be programmed by the server 3. In the embodiment, the first time interval T1 is between 1 sec and 60 sec. The second time interval T2 is between 10 ms and 1 sec. The arrangement of the second time interval in the first time interval can also be adjusted according to the practical requirement and programmed by the server 3, which is not limited in the present disclosure. In the embodiment, the first tracking device TD1 and the second tracking device TD2 are not necessary to transmit and listen to the detecting signals at any time, which the first tracking device TD1 and second tracking device TD2 of the location tracking system 1 just transmit and listen to the detecting signals in the second time intervals of the first time intervals. Therefore, the power consumption of the first tracking device TD1 and the second tracking device TD2 can be reduced for power saving.

In the embodiment, the clock signals of the first tracking device TD1 and the second tracking device TD2 can synchronize with that of the server 3 through at least one electronic device (not shown) communicated with the first tracking device TD1 or the second tracking device TD2. In other embodiment, the first tracking device TD1 and the second tracking device TD2 can synchronize with the reference clock signal by listening to the broadcast signals transmitted by other tracking device.

According to the above, the tracking system in the present disclosure uses the tracking devices that synchronize with a reference clock signal of the sever, and the tracking devices transmit and listen to the detecting signals as the nodes of the mesh network in the same time interval for transmitting the events or the status of the tracking devices of the mesh networks to a remote server. The location of the tracking device can be determined, accordingly. The tracking device in the present disclosure includes a Bluetooth communication module or a Bluetooth low energy communication module, which the power consumption of those is lower.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A tracking device, used for communicating with an electronic device based on a Bluetooth standard, the tracking device comprising:
a processing module; and
a communication electrically connected to the processing module;
wherein the tracking device communicates with the electronic device through the communication module, the processing module of the tracking device receiving a second detecting signal of another tracking device for detecting the another tracking device through the communication module, the second detecting signal is a broadcast signal, when the tracking device listens to the second detecting signal of another tracking device, the electronic device provides a location signal to a server.

2. The tracking device of claim 1, wherein the communication module is a Bluetooth communication module or a Bluetooth low energy communication module.

3. The tracking device of claim 1, wherein the location signal includes a location information of the electronic device, a device code of the tracking device, and a device code of the another tracking device.

4. The tracking device of claim 1, wherein tracking device is registered and enabled through at least one registering device.

5. The tracking device of claim 1, wherein when the another tracking device is detected by the tracking device in a predetermined detecting distance, the processing module of the tracking device transmits a notice signal to the electronic device through the communication module.

6. The tracking device of claim 1, wherein the at least one registering device includes a tablet, a personal computer, a mobile device, a router, a gateway and a wearable electronic device.

7. The tracking device of claim 1, wherein the tracking device and the another tracking device synchronize with a reference clock signal of a server, the tracking device and the another tracking device synchronously transmit and listen to signals in the same time interval of the reference clock.

8. A location tracking system comprising:
a first tracking device, transmitting and listening based on a reference clock signal; and
a second tracking device, transmitting and listening based on a reference clock signal;
a second tracking device, transmitting and listen based on the reference clock signal;
wherein the reference clock signal includes a plurality of first time intervals, each first time interval includes one second time interval, wherein the first tracking device and the second tracking device transmit and listen to broadcast signals in the second time intervals of each first time interval.

9. The location tracking system of claim 8, wherein the reference clock signal is a reference clock signal of a server.

10. The location tracking system of claim 9, wherein the first time interval and the second time interval are variable and programmable.

11. The location tracking system of claim 10, arrangements of the second time intervals in each first time interval are the same.

12. A location tracking system comprising:
a tracking device;
a first communication device;
a second communication device; and
five fixed stations located in a predetermined area, each of the five fixed stations transmitting event signals to a server through the first communication device or the second communication device when an event is triggered, the each fixed station having a fixed station code;
wherein the first communication device transmits a first ping request to the five fixed stations and records a first ping request time, each of the five fixed stations transmits a first response signal to the first communication device according to the first ping request corresponding to the first ping request, the second communication device transmits a second ping request to the five fixed stations and records a second ping request time corresponding to the second ping request, each of the five fixed stations transmits a second response signal to the second communication device according to the second ping request, when the first communication device or second communication device receives the response signals of the fixed stations, the first communication device or the second communication device records each receiving time of the response signals of the fixed stations transmitted by the fixed stations to the first communication device or the second communication device, the first communication device determines first elapsed times of the fixed stations based on the response times of the fixed stations and the first ping request time, the second communication device determines second elapsed times of the fixed stations based on the response times of the fixed stations and the second ping request time, the first communication device and the second communication device transmit the first elapsed times of the fixed stations, the second elapsed times of the fixed stations to the server, the server generates a maximum delivery time interval based on the first elapsed times of the fixed stations and the second elapsed times;
wherein when the tracking device enters the predetermined area, at least one of the fixed stations detects the tracking device and transmits the event signal that the tracking device enters the predetermined area to the server through the first communication device or the second communication device, the first communication device and the second communication device transmit the event signal and detecting time of the event signal that is detected by the one of the fixed stations to the server, the detecting time of the event signal are determined by the first communication device or the second communication device based on receiving times of the event signal received by the first communication device or the second communication device and the elapsed times of the one of the fixed stations recorded in the first communication device or the second communication device, the event signal includes the fixed station code of the at least one of the fixed stations that detects the tracking device, when the server determines the maximum delivery time interval, the server transmits the maximum delivery time interval to the first communication device and the second communication device to notice all the fixed stations for transmitting the event signals in the maximum delivery time interval, the event signal detected by one fixed station is transmitted to the server only one time in one maximum delivery time interval.
